(19) United States
(12) Patent Application Publication
(10) Pub. No.: US 2007/0203933 A1
(43) Pub. Date: Aug. 30, 2007

(54) Method for generating data warehouses and OLAP cubes

(76) Inventors: Heine Krog Iversen, Tommerup (DK); Thomas Christiansen, Losning (DK)

Correspondence Address: KNOBBE MARTENS OLSON & BEAR LLP, 2040 MAIN STREET, FOURTEENTH FLOOR, IRVINE, CA, 92614, US

(21) Appl. No.: 11/361,512

(22) Filed: Feb. 24, 2006

(51) Int. Cl. G06F 7/00

(52) U.S. Cl. 707/102

(57) ABSTRACT

The present invention provides an automated data warehousing and OLAP cube building process. The invention allows a person who is not a database query language expert to build validated data warehouses, and OLAP cubes based on such data warehouses.

### FIELD OF THE INVENTION

The present invention relates to a method for automatically generating data warehouses and OLAP cubes.

### BACKGROUND OF THE INVENTION

Business intelligence systems are crucial tools in today's hugely complex data environment. Business Intelligence is formed by collecting, storing and analyzing data as support in more or less critical decision-making processes. Example usage includes market segmentation, product profitability, inventory and distribution analysis.

Companies collect large amounts of data in their business operations utilizing a wide range of software programs, such as ERP and CRM systems, spreadsheets, and various more or less custom-tailored data handling systems. Different information systems use different data structures and information fields. Retrieving and analyzing information from a range of unaligned systems is presently a tedious and resource-demanding process that requires expert assistance. Like most “programming languages”, SQL and other query languages (such as Business System 12, Hibernate Query Language (HQL) and Object-oriented SQL), are essentially a specialists' language, generally not accessible to the average person skilled in making business decisions based on business intelligence.

In reality, the technical formation of business intelligence in an organization often relies on highly trained IT personnel with extensive programming knowledge. Unfortunately, this training is rarely paired with business intelligence skills, and thus the technical implementers typically can not add much perspective on the business intelligence side.

The process of actually building business intelligence solutions is often iterative. Given that highly trained IT personnel provide the technical support, the process requires business intelligence staff to verify data from the IT personnel and report back with errors, if identified. Business intelligence staff will then return with a specification of how the errors are to be corrected.

In the end, no one person can claim ownership to the solution. Business intelligence staff specifies but does not implement data warehousing, and IT personnel implements, but does not specify data warehousing.

When business intelligence staff specifies new business intelligence solutions, however small the changes may be compared to previous solutions, they require that a new data warehouse is built from the ground and up. The reason is that specification changes are so pervasive in the building process, a fact that is mirrored in the pervasiveness of the changes that IT personnel must make in existing query code is order to meet the modified specifications. Again, errors are likely during the implementation and are typically discovered only through rigorous testing procedures.

To illustrate the tediousness of existing methods of building business intelligence solutions, we will briefly discuss the following “Customer” table:

| CustomerId | CustomerName | Country | Group |
|---|---|---|---|
| 1 | John Doe | DK | 1 |
| 2 | Jane Doe | DE | 1 |
| 3 | Large Corp Inc | NZ | 2 |
| 4 | Small Corp Inc | IT | 2 |
| 5 | International Traders | US | 3 |
| 6 | First Class Imports | AU | 3 |

In a conventional setting, using for instance SQL Server, “Customer” data may be transferred from a data “Source” to a data “Destination”, as illustrated in FIG. 1, using the illustrated manually coded SQL query in FIG. 1. FIG. 2 illustrates the field mapping definition used when forming the “Destination”. In the present example, a field named “DW_SourceCode” is added in the “Source”. It is defined to contain the name of the data source, “Sales” in this example. That is, the “Sales” data source contains the table “Customer”. In the example, the “Destination” also has an extra added field, “DW_TimeStamp”.

In SQL Server, viewing this “Destination” table might look like FIG. 3, where we have named the destination table “Sales_Customer_R”.

In the case described above, we selected all fields in the “Customer” table. A change in our selection, such as by removing a field, would require that we modify the code accordingly. Had we made a smaller selection, such as “CustomerId”+“CustomerName”, and wanted to change it to “CustomerId”+“Country”+“GroupId”, we would need to implement this change in the code accordingly. In case we need data from several tables, for instance 5 different tables, changes must be made in a number of SQL segments, depending on the relationship between the fields in the different tables. This is time consuming, and changing specifications back and forth, or incorporating a “Customer”-like table with another format (the fields may have different names, for instance), requires pervasive modification of SQL segments. When moving on in the business intelligence building process, to tasks such data transfer, validation and viewing etc., a change in the business intelligence specification will involve changes in yet another set of SQL segments. Changes in table and field selections will carry through from the table definition in the beginning, to the creation of views or building of OLAP cubes at the other end of the process. This propagation of small changes far into the SQL code clearly illustrates the large degree of code redundancy that manual data warehouse and OLAP cube building involves.

The processes above being both error-prone and tremendously time-consuming, it is clear that there is a need for a simplified method of building data warehouses and OLAP cubes. Such a method must provide mechanisms that reduce the possibility of introducing coding errors during the data warehouse and OLAP cube building, and it must reduce the redundancy of information provided when building the data warehouse and OLAP cube.

### BRIEF DESCRIPTION OF THE DRAWINGS

FIG. 1 illustrates using manually coded SQL query.

FIG. 2 illustrates the field mapping definition used when forming the “Destination”. In SQL Server, viewing this “Destination” table might look like FIG. 3, where we have named the destination table “Sales_Customer

FIG. 3 illustrates a “Destination” table.

FIG. 4 illustrates an example where a data source “Sales” has been provided and translated using a data dictionary.

FIGS. 5 and 6 illustrate interfaces for providing an Oracle source and an Excel source, respectively.

FIG. 7 illustrates a typical system process of forming a data warehouse and OLAP cubes.

FIG. 8 illustrates a typical flow diagram for a method in accordance with one embodiment.

FIG. 9 illustrates the structure of the sample data source “Sales.”

FIGS. 10 to 12 illustrate the definition of the tables “Customer”, “OrderLines” and “History_OrderLines”.

FIG. 13 illustrates a project “Sample project.”

FIG. 14 illustrates the creation of a staging database.

FIG. 15 illustrates the tables and fields of a data source named “Sales”.

FIG. 16 illustrates the raw table “Sales_OrderLines_R” and its fields created on the staging database resulting from the user having selected the corresponding fields under “OrderLines” in the data source representation in FIG. 15.

FIG. 17 illustrates the valid table “Sales_OrderLines_V.”

FIG. 18 illustrates error table “Sales_OrderLines_E.”

FIG. 19 illustrates a view used for generating a cube name “Sales”.

FIG. 20 shows an overview of the DTS packages that copy the selected table tables from the data sources to the staging database.

FIG. 21 illustrates a “Sales” cube having dimensions “Product”, “Customer”, and “Region”.

FIG. 22 illustrates the definition of a measure

FIG. 23 illustrates a calculated measure

FIG. 24 illustrates a calculated measure

FIG. 25 illustrates an example of how such a notification may be presented to the user.

FIG. 26 illustrates what the final cube looks like.

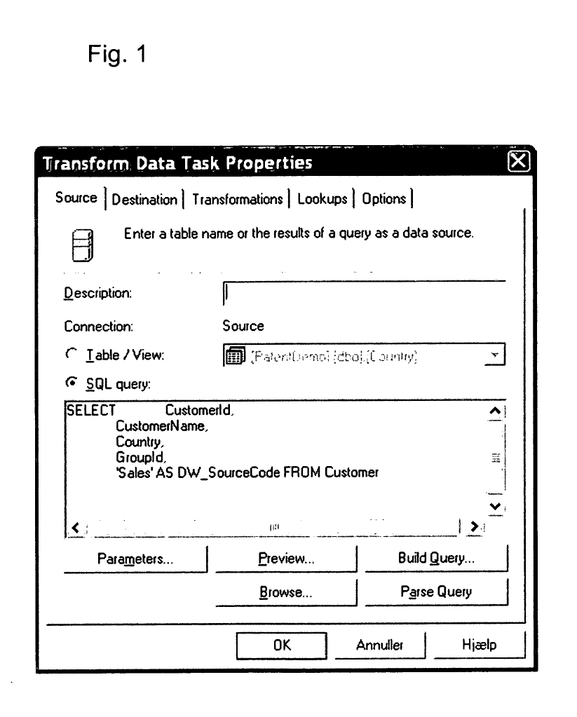

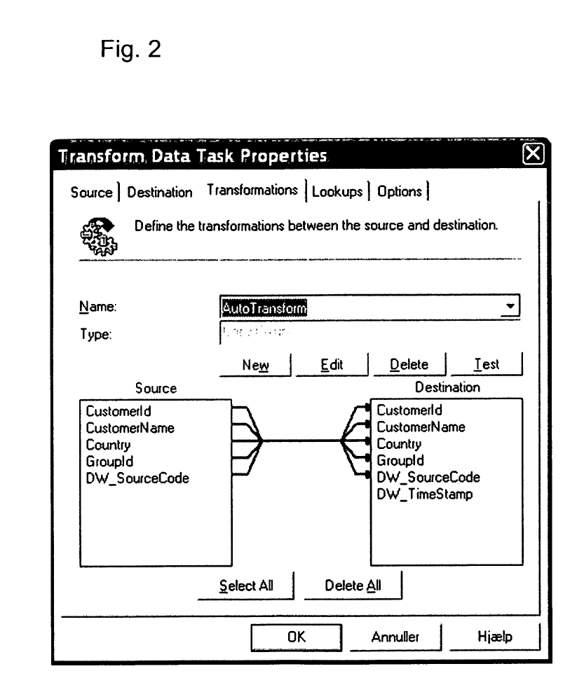

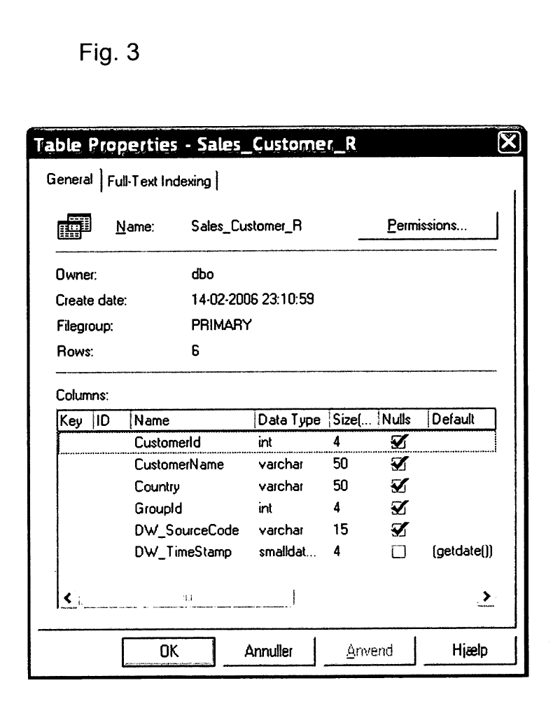

### SUMMARY OF THE INVENTION

The present invention solves the problems described above by providing an automated data warehousing and OLAP cube building process. The invention allows a person who is not a database query language expert to build validated data warehouses, and OLAP cubes based on such data warehouses.

In a first aspect, a method is provided that allows a user to generate an OLAP cube based on one or more data sources comprising a set of source tables having a set of source fields, the method comprising the steps of:
initializing an execution script to be adapted to generate, when executed, a data warehouse holding validated data based on said one or more data sources, the execution script also being adapted to comprise execution stubs, execution stubs being predefined database query language segments consisting of one or more database manipulation commands that may depend on parameters and selections provided with relation to said data sources;
the user forming a data selection consisting of a set of tables and a set of fields selected from the source table and source fields;
for each table in said data selection:
   adding to the execution script a table-specific execution stub representing a creation of a table-specific valid table, said valid table being a table adapted to hold validated rows, validated rows being rows that belong to said each table and comply with a table-specific set of validation rules provided for said each table, a validation rule being a field-specific condition that said specific field must fulfill;
   adding to the execution script a table-specific execution stub adapted to determine whether each row in said each table complies with the table-specific set of validation rules and if so, to insert said row into the table-specific valid table;
optionally creating a set of data warehouse views based on one or more of the valid tables that are to form part of said data warehouse, each data warehouse view being formed by carrying out at least the steps of:
   the user selecting from the set of tables in the data selection a view-specific first view table to be used in said view;
   the user selecting one or more fields from said view-specific first view table;
   optionally:
      the user selecting, from the set of tables in the data selection, a view-specific second view table to be used in said view;
      the user selecting one or more fields from said view-specific second view table;
      the user providing a join criterion for joining said view-specific first and second view tables;
   providing a name for said data warehouse view;
   adding to the execution script a view execution stub representing a creation of said data warehouse view having said name and containing said selected fields from said view-specific first view table, said view execution stub further comprising, on the condition that said view-specific second view table has been selected, statements representing:
      an inclusion of said selected fields from said view-specific second view table into said data warehouse view;
      the provided join criterion;
executing the execution script to form said data warehouse;
initializing a cube generation instruction set for generating said cube, a cube generation instruction set being a set of instructions that can interact with an Application Programming Interface (API) of an OLAP cube generation software application and cause said software application to generate an OLAP cube;
the user selecting a fact table for said cube, the fact table being either:
   a table selected from the data warehouse; or
   a view selected from the set data warehouse views, if created;
the user providing one or more cube dimensions that are to form part of said cube;
for each of said dimensions:
   the user selecting a dimension-specific set of dimension tables on which said dimension shall be based, each dimension-specific table in said dimension-specific set of dimension tables forming a basis for one or more table-specific levels belonging to said dimension, the dimension-specific set of dimension tables being selected from one or both of:
      the data warehouse;
      the set of data warehouse views, if created;
   for each dimension table in said dimension-specific set of dimension tables:
      the user selecting, from said dimension table, a level-specific key field and a level-specific name field to form a level;
the user providing a set of measures that are to form part of said cube, each measure being provided with a measure-specific aggregation type, each measure being one of:
   a standard measure based on a measure-specific field in the fact table;
   a derived measure based on one or more fields in the fact table, said derived measure being calculated based on a measure-specific formula adapted to operate on said one or more fields, derived measures being calculated before aggregation is performed on said measure in accordance with said measure-specific aggregation type;
   a calculated measure based on:
      one or more fields in the fact table; and/or
      another standard measure or measures from the set of measures, if applicable; and/or
      another calculated measure or measures from the set of measures, if applicable;
   a calculation of a calculated measure being characterized by a multidimensional expression specific to said calculated measure;
adding to the cube generation instruction set a set of API instructions representing at least:
   said provision of said dimensions;
   said provision of said fact table;
   said selection of said dimension-specific sets of dimension tables;
   said selection of said level-specific key fields and name fields;
   said provision of said measures;
providing said instruction set to said software application and executing said software application, thereby generating said cube.

An OLAP cube is a database model that treats data not as relational tables and columns, but as categorized and summarized information stored in cells. A cube comprises dimensions, measures and a fact table.

A measure is a set of values that are based on a field in the cube's fact table. Measures are usually based on numeric fields, such as an item quantity or a currency amount, but could also be a count of character-based fields. Measures are calculated for all possible combinations of dimension values and are stored in the cube cells. Each cell in a cube is addressed by a set of coordinates specifying a “position” in the cube.

A fact table is a table that contains numerical measures and keys (fields) relating facts to dimension tables.

The execution script is a cornerstone in the present invention. The execution script is built as the steps above are carried out. The steps add predefined execution stubs to the execution script. The most widely used database manipulation language is SQL, “Structured Query Language”, and in this case the execution stubs will be SQL language stubs. We point out that the principles of the invention do not rely on a specific query language.

The initialization of the execution script can mean to simply provide an empty text file. Execution stubs are added to the execution script by amending them to the file. Another example involves building the execution script in a computer memory.

Execution stubs are partly predefined, which is another cornerstone in the invention. A user needs not have any knowledge of SQL or other query language to use the method according to the first aspect to build a data warehouse. When he makes selections and provides parameters, the predefined SQL segments (execution stubs) are adjusted to reflect the selections and the parameters he provides.

Examples will be provided below. These examples are further described in “Detailed description of selected embodiments”.

According to the invention, data sources form the basis for OLAP cubes. A data source holds one or more tables, and a table holds a number of rows, each row consisting of at least one field. Once the data sources have been provided, table and field information for each of the data sources may be extracted for instance using appropriate data dictionaries. This information is then presented to the user, which may be done in several ways. Preferably, information is presented to the user via a user-friendly interface, such as a graphical user interface (GUI). A GUI also provides a practical way of allowing the user to provide the required input.

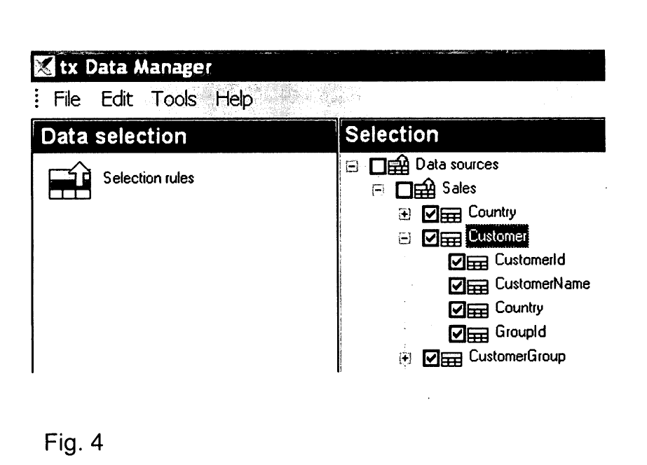

FIG. 4 illustrates an example where a data source “Sales” has been provided and translated using a data dictionary, and finally is presented to the user by way of a graphical user interface. Tables “Country”, “Customer” and “CustomerGroup” are visible in the illustration. The figure also illustrates that the table “Customer” contains the fields “CustomerId”, “CustomerName”, “Country” and “GroupId”. The checkboxes in the graphical user interface allow the user to easily select or deselect specific tables and table fields.

FIG. 4 illustrates a specific data selection. In FIG. 4, all three tables and their fields have arbitrarily been selected. It is of course possible to select fewer tables, and fields may also be left out (not be selected) if they are not needed in the OLAP cube. Using a GUI, making or changing the data selection is easily done.

Having provided the data selection, a new table, a “valid table”, is created for each table in the data selection. Optionally, the definition of the table can constrain the contents of the fields, for instance using the NULL or NOT NULL statements in a CREATE TABLE function (using SQL terminology). It may be desirable to add extra fields when the valid tables are created. Extra fields can be used for comments. In any automated process, it is desirable to carry along documentation information. In the automated data warehousing process according the first aspect of the present invention, it may for instance be useful to store, in the valid table, information about the data source on which it is based. The time of row insertions into the tables is another useful parameter that one might include.

According to the invention, the execution stub is structurally predefined, but also adaptable to the data source and to the user's data selection. This will be further illustrated in “Detailed description of selected embodiments”.

In the present invention, OLAP cubes are built from the valid tables in a data warehouse, valid tables comprising validated (“scrubbed”) data from tables in the data sources. Data from the data selection must be validated before it is entered into the data warehouse. “Data scrubbing” is the process by which data from a data source is validated and invalid data from the data source is identified, removed or corrected. Despite the efforts made to ensure the data quality in the data sources, these efforts are not always adequate for meeting the requirements for building a valid business intelligence solution.

Data is validated on a table-by-table, row-by-row basis. For each table in the data selection (the tables and fields selected by the user), a set of validation rules are provided. These rules are responsible for the validation of the data. A useful rule might be that a field may not be NULL (or empty, if the field is a text field). An empty “CustomerId” is likely an error in the data provided to the database, and it is desirable to be aware of this error before data is entered into the data warehouse. Another useful rule might be that a field may not exceed a certain value. According to the invention, the validation rules are enforced by adding to the execution script execution stubs representing the desired validation criteria. Statements taking care of insertion of rows that comply with the table-specific set of validation rules are also added.

Selecting a specific validation rule type causes a specifically designed execution stub to be employed. In “Detailed description of selected embodiments”, a code example illustrates what a validation execution stub may look like.

The user may want to create a number data warehouse views. Views combine data from multiple tables into one logical object, which can be used as fact table for cubes. This solves a problem on SQL Server 2000, namely there can be only one fact table per cube.

A view is created by selecting a table on which the view shall be based and then selecting a number of view fields from the table which shall be used in the view. After forming the selection and providing a name for the view, an execution stub representing the creation of the view having the provided name and containing the selected fields is added to the execution script. The user may also selected more than one table for use in the view. Fields from across tables are logically combined using a join statement in the execution stub.

After forming the execution script as described, that execution script is executed, whereby the data warehouse is created.

The selections made thus far by the user continue to be used during the OLAP cube generation. Since the data warehouse is custom-built, the OLAP cube building has a natural outset. Rather than representing all information from the data sources to the user, only the data warehouse data is represented. Thus, the user needs not select a fact table for the cube from all tables in the data sources, many of which are likely completely unrelated and not even useful. Instead, he chooses from only the valid tables in the data warehouse or from the created views, if any. Clearly this is highly advantageous compared to separately building a data warehouse, and then subsequently providing the data selection information once again during the subsequent cube generation.

Next, the cube's dimensions are provided. Each dimension is based on a set of dimension tables, and thus for each dimension, a set of dimension tables must be provided. Again, not only tables from the data warehouse but also created views may be selected, and thus both valid tables and views can serve as dimension tables.

Levels are chosen for each dimension based on the selected dimension tables. For each level added to the dimension, a key field and a name field must be indicated.

Having completely defined the cube's dimensions, measures can be added. The measures are based on the fact table. There are three types of measures:
standard measures;
derived measured; and
calculated measures.

A standard measure is simply a field the fact table. A derived measure can be based on more than one field, and it may involve a calculation using the fields on which it is based. However, a derived measure is calculated before aggregation in the cube. A calculated measure may depend on one or more fields in the fact table, on standard measures, and on other calculated measures. The calculated measure is characterized by a multidimensional expression.

According to the method, the actual cube generation is performed via an Application Programming Interface (API) of a cube generation software application, for instance Analysis Management Objects (AMO); Decision Support Objects (DSO); or Oracle OLAP API. The selections made previously by the user are translated to “API” language, thereby obtaining an instruction set. The instruction may then be provided to the software application, which may then proceed to generate the cube. Depending on the application, it might be desirable to leave out the step of providing said instruction set to said software application and executing said software application.

It may be advantageous to also create an error table for each table in the data selection. Rows that do not comply with the validation rules may be inserted into the error table for easy overview by the data warehouse builder. In embodiment using error tables, execution stub representing the creation of the error tables are added to the execution script. Furthermore, execution stubs representing insertion of non-complying rows into the error tables are also added.

A table row that does not comply with the table-specific set of validation rules is inserted into the table-specific error table, and erroneous rows may then easily be reviewed along with the validation rules that they did not comply with. An execution stub that handles this is added to the execution script.

It should be obvious that the physical location of the data sources is not important in terms of carrying out the building of the data warehouse. It should also be obvious that the data processing may take place anywhere, as long as the data to be processed is accessible.

Data source servers are often running mission critical applications. Extraction of data from data sources servers should leave as small a footprint as possible in order to minimize the load on those servers. A staging database may advantageously be used for holding relevant data from data sources. The staging database may then act as a source for cubes. Using a staging database further has the advantage that data can be extracted selectively from the data sources using a set of selection rules. As an example, it may be desirable to extract only data that corresponding to sales postdating 2004, rather than extracting all data dating back to the earliest recorded data in the data source table.

In embodiments that employ a staging database, methods of building the data warehouse further comprise the steps of:
generating a staging database for holding staging data from said data sources, staging data being data that correspond to said data selection;
for each specific table in the data selection:
   adding to the execution script a table-specific execution stub representing a creation of a table-specific raw table in the staging database, said raw table being a table adapted to hold rows from said specific table;
copying, after the step of executing the execution script, each table in the data selection from its data source to said table's corresponding raw table in the staging database, optionally applying a set of table-specific selection rules during said copying of said each table, the table-specific selection rules causing said copying to transfer only a part of said each table that complies with said table-specific set of selection rules.

In this case the table-specific raw tables, valid tables, and error tables (if used) are created in the staging database.

Selection rules are table-by-table, field-by-field specific. In a typical implementation, the table-specific selection rules are automatically built into table-specific DTS packages used for copying data from the data source to the corresponding raw tables in the staging database. The selection would then be realized by adding WHERE statements (in SQL terminology) representing the table-specific selection rules. For automation purposes, the user preferably provides the set of selection rules via a user-friendly interface rather than by providing SQL code (such as actual WHERE statements) representing the table-specific selection rules.

All transformation, validation etc. may then be done on the staging database after the source data has been successfully copied to it.

It may be desirable to provide further processing rules, again in an automated fashion. For instance, the user may provide, for each field of each table in the data selection, a set of transformation rules to be applied to the data as it is transferred from the data sources to the data warehouse. The user may for instance have asked that all customer names in a specific table in the data selection be transferred in all upper case. The set of transformation rules are preferably provided via a user-friendly interface, such as a graphical user interface.

Employing a set of default rules may also be desirable, for instance for correcting systematic errors or for providing some sense to an empty field. An empty field may for instance be given a default value during the transfer. The user may indicate that if the field “CustomerName” in the “Customer” table is empty, it shall be given the value “(name not provided)”. This provides more useful information than does an empty field.

In some embodiments of the method according to the first aspect, relevant personnel will be notified in case a warning or error is identified. An email detailing the problem or an SMS (short message system) message, a fax, a page, an entry in an operating system event log; or some other type of notification with a more or less detailed description of the warning or error may be dispatched.

It is desirable to save all information relevant information pertaining to the data warehouse in a project file. The user can then return to the project at a later point and determine the structure of the data warehouse. This information is essentially a documentation of the data warehouse. Preferably, the project file is human readable. This makes it easier for a user to study the data warehouse structure.

A project file may easily be distributed to users elsewhere. Company business staff may for instance design business intelligence processes centrally, for instance by creating execution scripts relating to local business conditions. Regional offices can then directly implement the scripts and thereby handle local business intelligence themselves, but in a company-consistent fashion, what the company would consider “best practices”.

In a second aspect of the invention, a method is provided for allowing a user to generate a data warehouse holding validated information based on one or more data sources comprising a set of source tables having a set of source fields. The circumstances and variations described in relation to the first aspect above apply equally to the second aspect.

In a third aspect of the invention, software that implements the methods according to the invention is provided. Such software is capable of dispensing the execution stubs described above. Depending on a user's choices, the software will provide appropriately adapted execution stubs fitting the specific tasks. As described above, choosing a table and one or more of its fields causes a set of execution stubs to be added to the execution scripts, such as a valid table creation stub and a validation execution stub. The software may be capable of providing execution stubs in more than one query language. It may be capable of loading data from several types of data sources, such as vendor-specific customer relationship management systems; human resource management systems; enterprise resource planning systems; database systems, such as Oracle, SQL Server, and Microsoft Excel. Information about for instance tables, views, fields, data types and constraints is extracted from data sources using vendor specific schema information (“data dictionaries”). This information may for instance be extracted by connecting directly to the data sources using either managed .Net providers or legacy providers.

Methods according to the invention may also or alternatively be implemented directly in processing hardware, such as an application-specific integrated circuit, or some parts may be provided by software running on a hardware processor, and other parts may be implemented on an application-specific integrated circuit.

### DETAILED DESCRIPTION OF SELECTED EMBODIMENTS

The following example illustrates certain aspects of the invention.

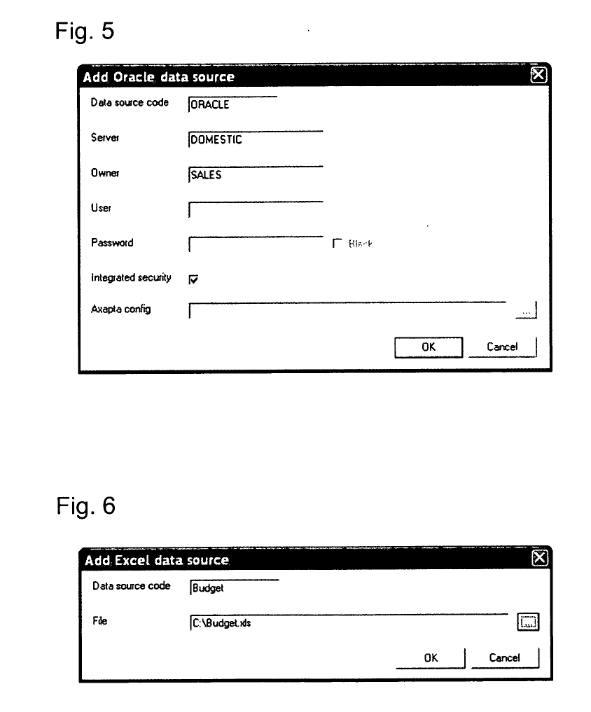

In a typical practical scenario, tables are located in more than on data source. For example, a company's product management division (handling for instance tables “Products”, “ProductCategory” and “ProductGroup”) may for instance operate two SQL servers and an Oracle database. On the other hand, the logistics division (handling for instance tables “OrderLines”, “Orders” and “Customers”) may operate three Oracle servers, and the occasional Microsoft Excel database. FIGS. 5 and 6 illustrate interfaces for providing an Oracle source and an Excel source, respectively.

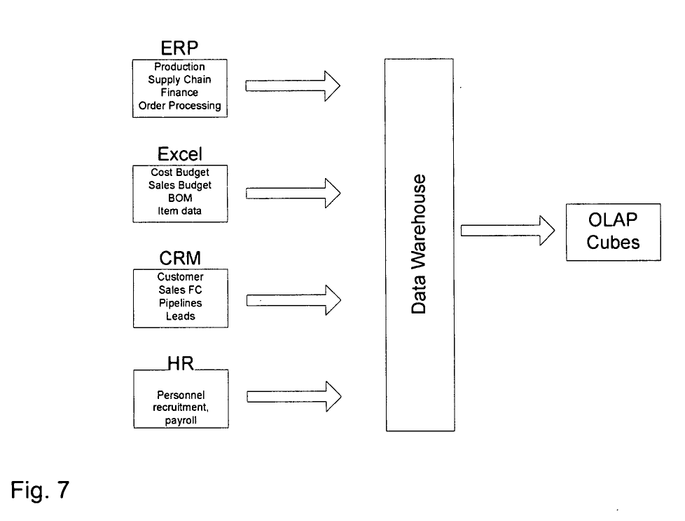

FIG. 7 illustrates a typical system process of forming a data warehouse and OLAP cubes. A number of data sources, such as an Enterprise Resource System source (“ERP” in FIG. 7), A Microsoft Excel source (“Excel” in FIG. 7), a Customer Relationship Management source (“CRM” in FIG. 7) and a Human Resource source (“HR” in FIG. 7) may form the basis for the data warehouse (“Data Warehouse” in FIG. 7) and OLAP cubes also illustrated in FIG. 7. Some methods according to the present invention allow a user to extract and validate data from the data sources and generate a data warehouse based thereon. Other methods according to the invention furthermore allow a user to first generate the data warehouse and then generate OLAP cubes based on the data warehouse.

Building a Data Warehouse and an OLAP Cube

In this example, the invention is implemented to use a graphical user interface.

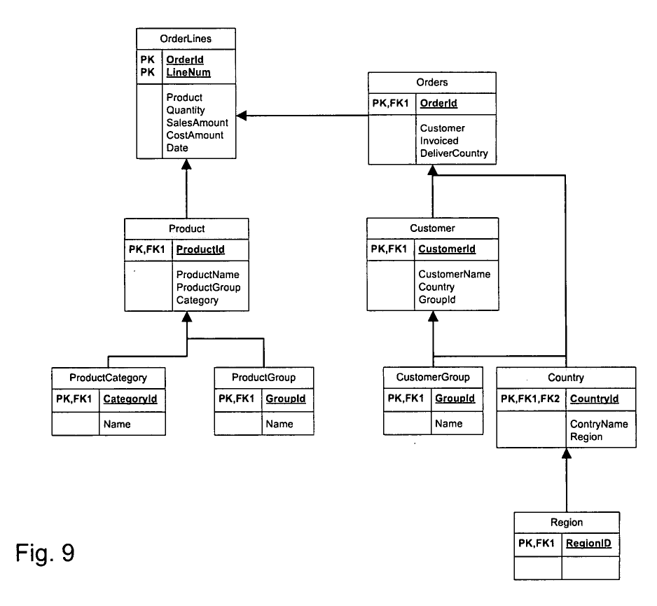

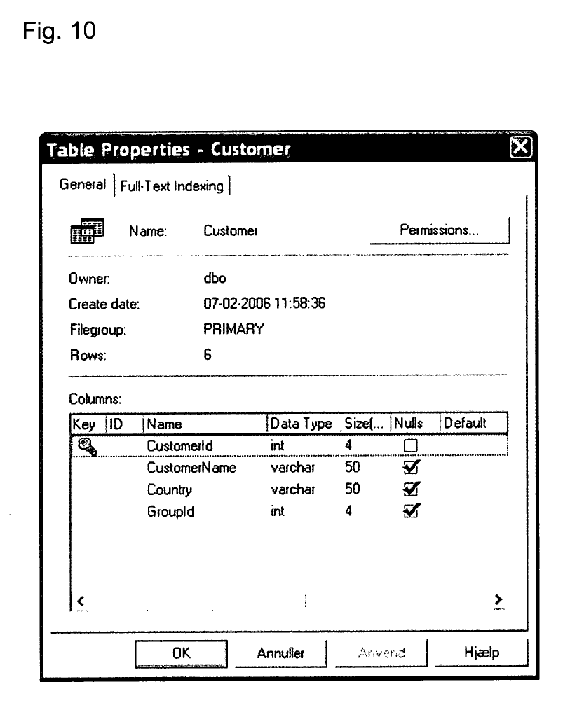

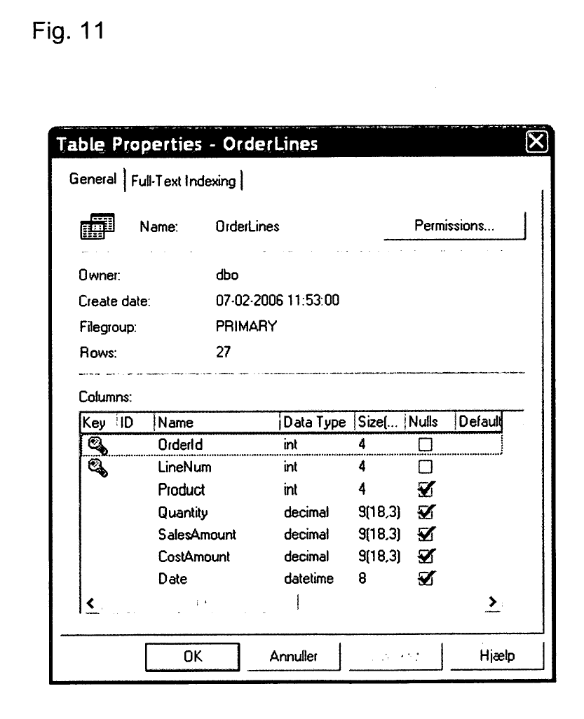

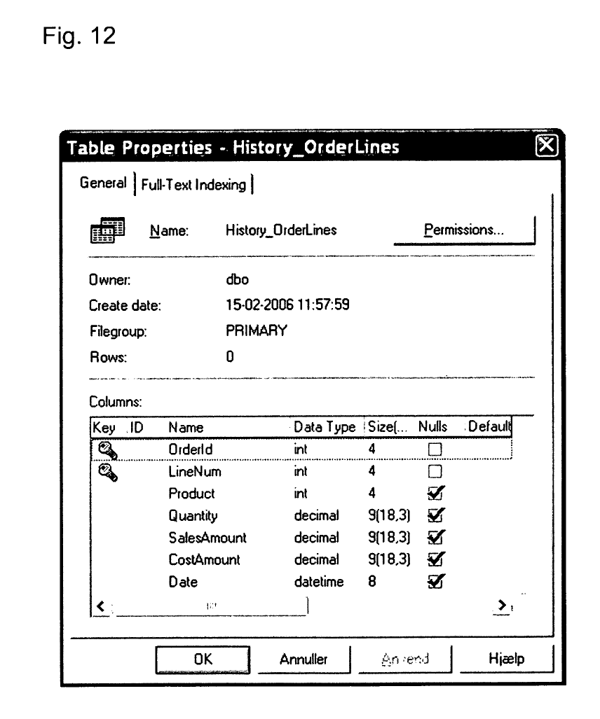

In the present example, all tables come from one data source, “Sales”. FIG. 9 illustrates the structure of the sample data source “Sales”, which may for instance be an Oracle database. FIG. 10 to FIG. 12 illustrate the definition of the tables “Customer”, “OrderLines” and “History_OrderLines”. The sample database contains a simple implementation of a sales order application.

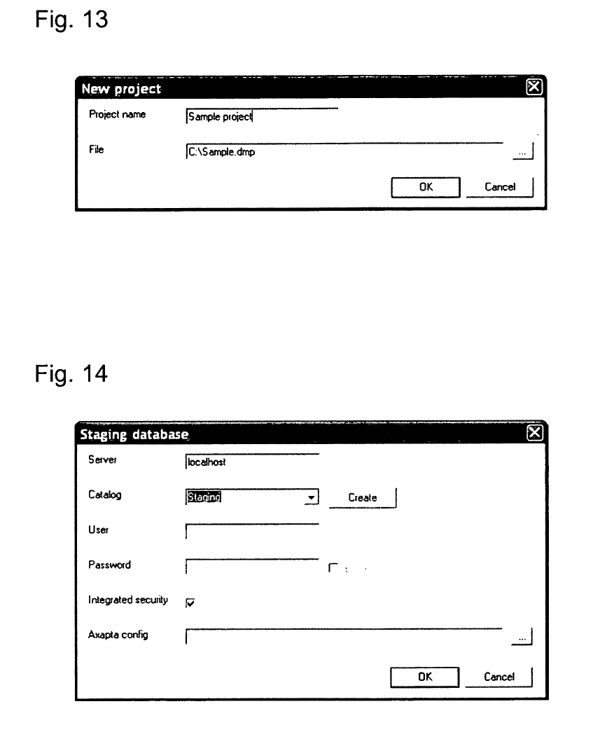

It might be useful to work inside the framework of a “project”. A project may for instance be a file. A specific project is capable of holding all relevant information that relate to execution of a corresponding specific method in accordance with the invention. We might therefore created a project first. A project is defined by providing a “Project name” and a “File path”. We choose “Sample project” as project name as illustrated in FIG. 13. The “File path” describes the desired location of the project. We name the project “Sample.dmp”. dmp” might stand for “data manager project”, Data Manager being the name of a software package implementing one or more methods according to the invention. The file is located in the root folder C:\.

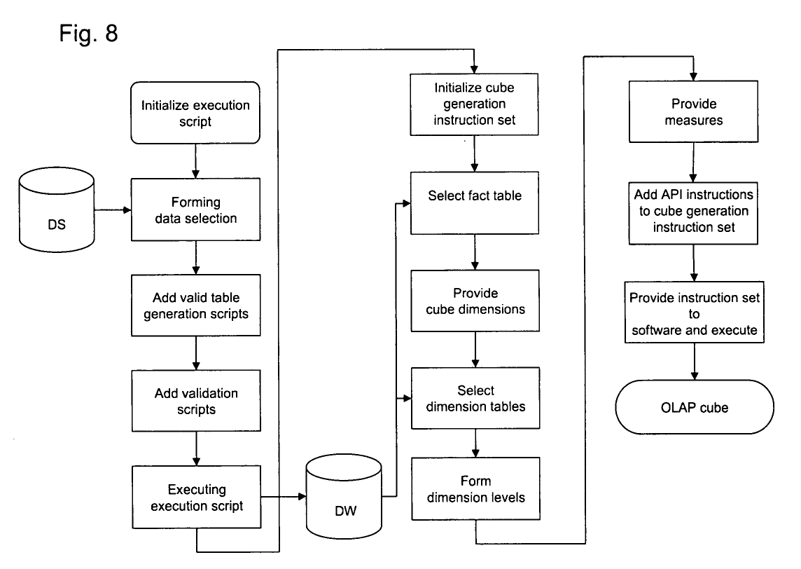

FIG. 8 illustrates a typical flow diagram for a method in accordance with the invention. The process spans from initializing the execution script, extracting data from data sources (“DS” in FIG. 8), generating a data warehouse (“DW” in FIG. 8), all the way to the generation of an OLAP cube using an OLAP cube generation software. A method according to the invention for generating a data warehouse of course comprises only a subset of the illustrated steps.

In the present implementation, the method creates not only a valid table and an error table for each source table, but also a “raw” table. The raw table is a table on a staging database to which data is transferred from the data source. Moving data from the data source to a staging database reduces the load on the data source servers. FIG. 14 illustrates the creation of a staging database.

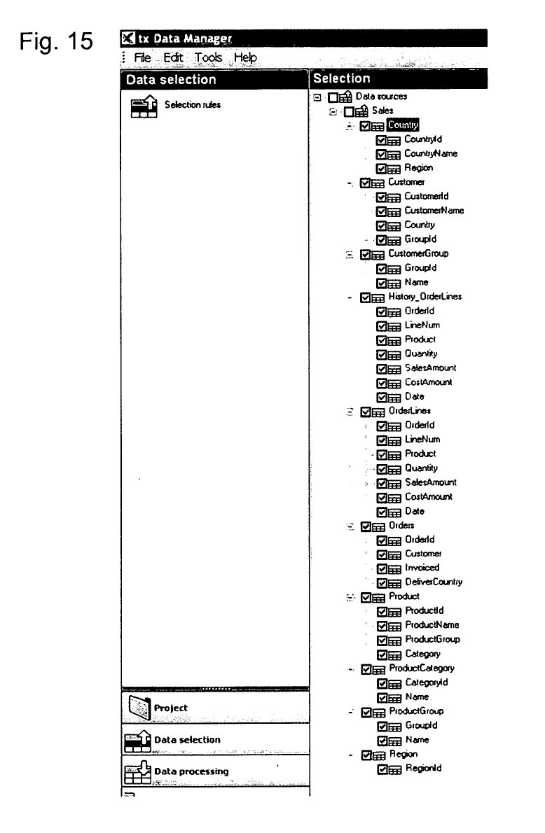

FIG. 15 illustrates the tables and fields of a data source named “Sales”. The user has selected all fields and tables from the data source. Having selected these fields, execution stubs are added to the project's execution script.

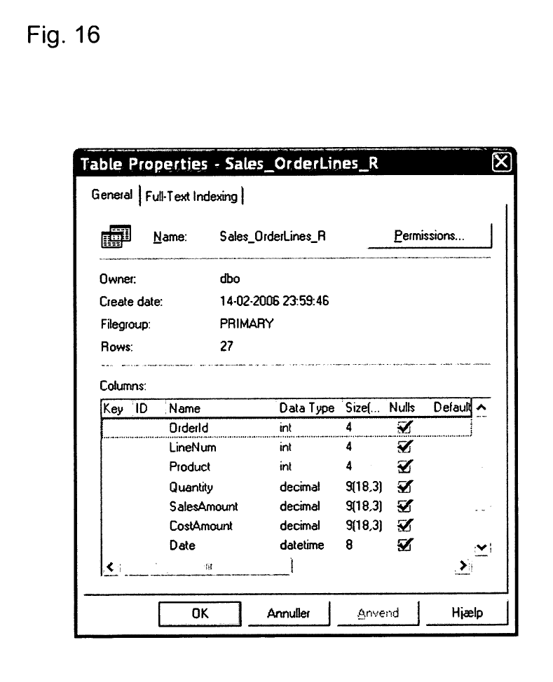

FIG. 16 illustrates the raw table “Sales_OrderLines_R” and its fields created on the staging database resulting from the user having selected the corresponding fields under “OrderLines” in the data source representation in FIG. 15. The raw table simply holds all data from the “OrderLines” table on the data source, whether they are valid or not. Data is simply transferred from the data source (“Sales”) to this table on the staging database. The same process takes place for the other tables in the data selection in FIG. 15.

The execution stub added to the execution script to create the raw table “Sales_OrderLines_R” in FIG. 16 is:

```
CREATE TABLE Sales_OrderLines_R(
      OrderId int NULL,
      LineNum int NULL,
      Product int NULL,
      Quantity decimal(18,3) NULL,
      SalesAmount decimal(18,3) NULL,
      CostAmount decimal(18,3) NULL,
      Date datetime NULL,
      DW_SourceCode varchar(15) NULL,
      DW_TimeStamp smalldatetime NOT NULL default(getdate( ))
)
```

Clearly, the execution stub represents the selections made by the user. However, its structure is predefined, in accordance with the invention. This is one of very important advantageous of the present invention.

As described previously, it may for instance be useful to store extra information in the created tables. Two fields, “DW_SourceCode” and “DW_TimeStamp” have been added in the creation of the raw table above for practical purposes. DW_SourceCode” may contain the name of the data source, “Sales” in this example (the “Sales” data source contains the “Customer” table). The field “DW_TimeStamp” may contain the time a row is inserted into the raw table. The field “DW_TimeStamp” is given a default value of getdate( ).

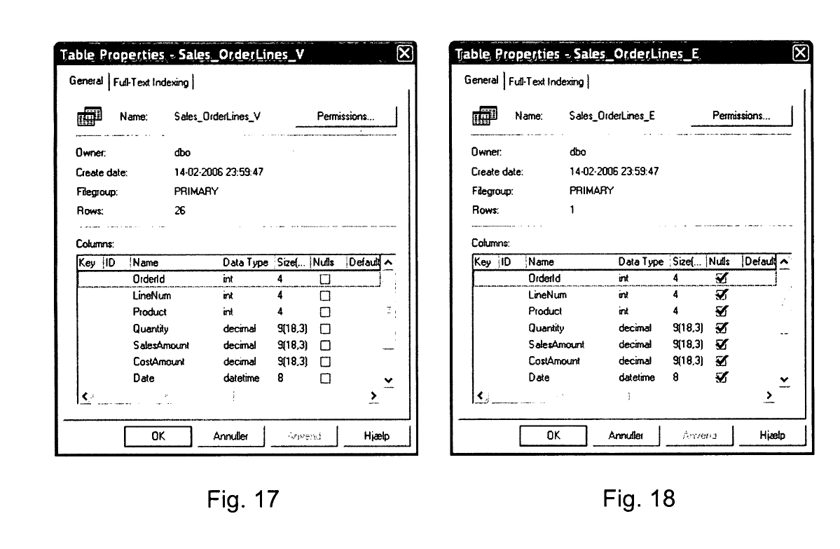

The execution stub added to the execution script to create the valid table “Sales_OrderLines_V” in FIG. 17 is:

```
CREATE TABLE Sales_OrderLines_V(
      OrderId int NOT NULL,
      LineNum int NOT NULL,
      Product int NOT NULL,
      Quantity decimal(18,3) NOT NULL,
      SalesAmount decimal(18,3) NOT NULL,
      CostAmount decimal(18,3) NOT NULL,
      Date datetime NOT NULL,
      DW_SourceCode varchar(15) NULL,
      DW_TimeStamp smalldatetime NOT NULL default(getdate( ))
)
```

Finally, the execution stub

```
CREATE TABLE Sales_OrderLines_E(
      OrderId int NULL,
      LineNum int NULL,
      Product int NULL,
      Quantity decimal(18,3) NULL,
      SalesAmount decimal(18,3) NULL,
      CostAmount decimal(18,3) NULL,
      Date datetime NULL,
      DW_Severity varchar(1) NOT NULL,
      DW_ErrorMessage varchar(1000) NOT NULL,
      DW_SourceCode varchar(15) NULL,
      DW_TimeStamp smalldatetime NOT NULL default(getdate( ))
)
```

takes care of the creation of the error table “Sales_OrderLines_E” in FIG. 18. In the error table above, four extra fields are created: “DW_Severity”, “DW_ErrorMessage”, “DW_SourceCode”, and “DW_TimeStamp”. The field “DW_Severity” may be useful for indicating whether insertion of a specific row into the error table is triggered by for instance a “warning” or an “error”. Different actions may be taken depending on a severity parameter. Errors and warnings might be defined as:

| Severity | Description |
|---|---|
| Error | Used for restrictions on the source data which is critical for |
| | the data quality and subsequently the quality of the decisions |
| | made based on the information in the business intelligence |
| | solution. If the data does not comply with the validation rule, |
| | an error flag is raised and an error message generated. |
| | The entire row will then only be inserted into the error table. |
| Warning | Used for restrictions on a source data which is potentially |
| | erroneous, but not critical for the data quality. |
| | If the data does not comply with the validation rule, a warning |
| | flag is raised and a warning message generated. The entire |
| | row will be inserted into both the error table and the |
| | valid table. |

“DW_ErrorMessage” might contain a message relating to the specific warning or error that caused a specific row to be inserted into the error table. In the present example, “DW_SourceCode” and “DW_TimeStamp” have the same meaning described for the valid table.

The valid table in FIG. 17 and the error table in FIG. 18 are created to having the same fields as the raw table, which in turn contains the fields selected by the user, as illustrated in FIG. 15. Again, a valid table and an error table are generated for each of the tables selected by the user. This means that a raw table, a valid table and an error table are created for all the tables in FIG. 9.

To insert rows from the raw table “Sales_OrderLines_R” into the corresponding valid table “Sales_Orderlines_V”, the following execution stub is added to the execution script:

```
CREATE PROC dbo.usp_Sales_OrderLines_V_Insert
    @OrderId int,
    @LineNum int,
    @Product int,
    @Quantity decimal(18,3),
    @SalesAmount decimal(18,3),
    @CostAmount decimal(18,3),
    @Date datetime,
    @DW_SourceCode varchar(15)
AS
INSERT INTO dbo.Sales_OrderLines_V( OrderId,
    LineNum,
    Product,
    Quantity,
    SalesAmount,
    CostAmount,
    Date,
    DW_SourceCode)
VALUES(
    @OrderId,
    @LineNum,
    @Product,
    @Quantity,
    @SalesAmount,
    @CostAmount,
    @Date,
    @DW_SourceCode)
```

This execution script also generated using only the data selection information already provided. Thus, again the execution stub represents the selections made by the user, but is structurally predefined. Manual labor is optional, not mandatory.

An execution stub for inserting a row into the error table may look similar, for instance like this:

```
CREATE PROC dbo.usp_Sales_OrderLines_E_Insert
    @OrderId int,
    @LineNum int,
    @Product int,
    @Quantity decimal(18,3),
    @SalesAmount decimal(18,3),
    @CostAmount decimal(18,3),
    @Date datetime,
    @DW_SourceCode varchar(15),
    @DW_Severity varchar(1),
    @DW_ErrorMessage varchar(1000)
AS
INSERT INTO dbo.Sales_OrderLines_E( OrderId,
    LineNum,
    Product,
    Quantity,
    SalesAmount,
    CostAmount,
    Date,
    DW_SourceCode,
    DW_Severity,
    DW_ErrorMessage)
VALUES(
    @OrderId,
    @LineNum,
    @Product,
    @Quantity,
    @SalesAmount,
    @CostAmount,
    @Date,
    @DW_SourceCode,
    @DW_Severity,
    @DW_ErrorMessage)
```

An execution stub for determining whether a row is valid may have the following structure (sometimes referred to as “data scrubbing”):

```
CREATE PROCEDURE dbo.usp_Sales_OrderLines_Clean @Debug bit AS
SET NOCOUNT ON
      DECLARE @OrderId int
      DECLARE @LineNum int
      DECLARE @Product int
      DECLARE @Quantity decimal(18,3)
      DECLARE @SalesAmount decimal(18,3)
      DECLARE @CostAmount decimal(18,3)
      DECLARE @Date datetime
      DECLARE @Counter int
      DECLARE @Error int
      DECLARE @Warning int
      DECLARE @DW_ErrorMessage varchar(1000)
      DECLARE @DW_WarningMessage varchar(1000)
      DECLARE @DW_SourceCode varchar(15)
      DECLARE @DW_TimeStamp smalldatetime
SET @Counter = 0
DECLARE Sales_OrderLines_Cursor CURSOR FAST_FORWARD READ_ONLY FOR
SELECT OrderId,
      LineNum,
      Product,
      Quantity,
      SalesAmount,
      CostAmount,
      Date,
      DW_SourceCode
      FROM  Sales_OrderLines_R
BEGIN TRANSACTION
OPEN Sales_OrderLines_Cursor
FETCH NEXT FROM Sales_OrderLines_Cursor
INTO  @OrderId,
      @LineNum,
      @Product,
      @Quantity,
      @SalesAmount,
      @CostAmount,
      @Date,
      @DW_SourceCode
WHILE @@FETCH_STATUS = 0
BEGIN
      SET @Counter = @Counter + 1
      SET @Error = 0
      SET @Warning = 0
      SET @DW_WarningMessage = ”
      SET @DW_ErrorMessage = ”
      IF(@OrderId IS NULL)
      BEGIN
            SET @Error = 1
            SET @DW_ErrorMessage = ISNULL(@DW_ErrorMessage, ”) + ‘, OrderId does not comply with
validation rule Not empty’
      END
      IF(@LineNum IS NULL)
      BEGIN
            SET @Error = 1
            SET @DW_ErrorMessage = ISNULL(@DW_ErrorMessage, ”) + ‘, LineNum does not comply with
validation rule Not empty’
      END
      IF(@Product IS NULL)
      BEGIN
            SET @Error = 1
            SET @DW_ErrorMessage = ISNULL(@DW_ErrorMessage, ”) + ‘, Product does not comply with
validation rule Not empty’
      END
      IF(@Quantity IS NULL)
      BEGIN
            SET @Error = 1
            SET @DW_ErrorMessage = ISNULL(@DW_ErrorMessage, ”) + ‘, Quantity does not comply with
validation rule Not empty’
      END
      IF(@SalesAmount IS NULL)
      BEGIN
            SET @Error = 1
            SET @DW_ErrorMessage = ISNULL(@DW_ErrorMessage, ”) + ‘, SalesAmount does not comply with
validation rule Not empty’
      END
      IF(@CostAmount IS NULL)
      BEGIN
            SET @Error = 1
            SET @DW_ErrorMessage = ISNULL(@DW_ErrorMessage, ”) + ‘, CostAmount does not comply with
validation rule Not empty’
      END
      IF(@Date IS NULL OR @Date = ”)
      BEGIN
            SET @Error = 1
            SET @DW_ErrorMessage = ISNULL(@DW_ErrorMessage, ”) + ‘, Date does not comply with validation
rule Not empty’
      END
      IF(@Warning = 1)
      BEGIN
      /* Insert into error table */
      SET @DW_WarningMessage = RIGHT(@DW_WarningMessage, LEN(@DW_WarningMessage) −2)
      exec usp_Sales_OrderLines_E_Insert
            @OrderId,
      @LineNum,
      @Product,
      @Quantity,
      @SalesAmount,
      @CostAmount,
      @Date,
      @DW_SourceCode,
      ‘W’,
      @DW_WarningMessage
      IF(@Debug = 1)
      BEGIN
      PRINT @DW_WarningMessage
      END
      END
      IF(@Error = 1)
      BEGIN
      /* Insert into error table */
      SET @DW_ErrorMessage = RIGHT( @DW_ErrorMessage, LEN (@DW_ErrorMessage) −2)
      exec usp_Sales_OrderLines_E_Insert
            @OrderId,
      @LineNum,
      @Product,
      @Quantity,
      @SalesAmount,
      @CostAmount,
      @Date,
      @DW_SourceCode,
      ‘E’,
      @DW_ErrorMessage
      IF(@Debug = 1)
      BEGIN
      PRINT @DW_ErrorMessage
      END
      END
      IF(@Error = 0)
      BEGIN
      /* Insert into validated table */
      exec usp_Sales_OrderLines_V_Insert
            @OrderId,
      @LineNum,
      @Product,
      @Quantity,
      @SalesAmount,
      @CostAmount,
      @Date,
      @DW_SourceCode
      END
      IF((@Counter % 1000) = 0)
      BEGIN
      SAVE TRANSACTION Sales_OrderLines
      IF(@Debug = 1)
      BEGIN
      print ‘Transaction saved @ ’ + convert(varchar, @Counter)
      END
      END
      FETCH NEXT FROM Sales_OrderLines_Cursor
      INTO  @OrderId,
      @LineNum,
      @Product,
      @Quantity,
      @SalesAmount,
      @CostAmount,
      @Date,
      @DW_SourceCode
      END
      CLOSE Sales_OrderLines_Cursor
      DEALLOCATE Sales_OrderLines_Cursor
      COMMIT TRANSACTION
GO
EXEC dbo.usp_Sales_OrderLines_Clean 0
```

The structure of the execution stub is once again predefined, adjusted according to the data selection made by the user. The set of validation rules provided for the “OrderLines” table from the “Sales” data source are incorporated automatically in accordance with the method. In the example above, for simplicity, we apply the same validation rule for all fields in all tables, namely that they cannot be NULL or empty. In the present example, we do not employ transformation rules or default rules.

If the user has asked that all Product names be transferred in all uppercase, an execution stub such as

SET @Product=UPPER(@Product)

might be incorporated into the execution stub “CREATE PROCEDURE dbo.usp_Sales_OrderLines_Clean” illustrated previously. Again, this will be performed automatically, based on the user's indication.

The execution stub

IF(@Product IS NULL OR @Product = ”)
BEGIN
SET @Product = ‘0’
END

might be incorporated into the execution stub “CREATE PROCEDURE dbo.usp_Sales_Customer_Clean” illustrated previously.

The above execution stub also illustrates a use of the severity rating described previously.

The execution stubs above are provided only for exemplification. The structure of execution stubs is defined by the aspect formulation, not by the examples above. Clearly, the functions may be literally different from those above, but still implement the same functions. The extra fields illustrated above may be left out, others may be inserted; tables can be defined with other NULL/NOT NULL constraints than those shown in the examples; further SELECT statements and/or WHERE statements can be inserted; and so on.

The following table illustrates various validation rules that a user may find useful:

| Type | Description |
|---|---|
| NotEmpty | Field value can not be NULL and for text data types, |
| | can not be blank/empty |
| Equal | Field value has to be equal to the specified single value |
| GreaterThan | Field value has to be greater than the specified single value |
| LessThan | Field value has to be less than the specified single value |
| NotEqual | Field value has to be different from the specified single |
| | value |
| GreaterEqual | Field value has to be greater than or equal to the |
| | specified single value |
| LessEqual | Field value has to be less than or equal to the specified |
| | single value |
| MinLength | Length of field value has to be at least the specified positive |
| | integer value |
| MaxLength | Length of field value has to be less than or equal to the |
| | specified positive integer value |
| List | Field value has to be equal to one of the values in the |
| | specified comma-separated list of values |

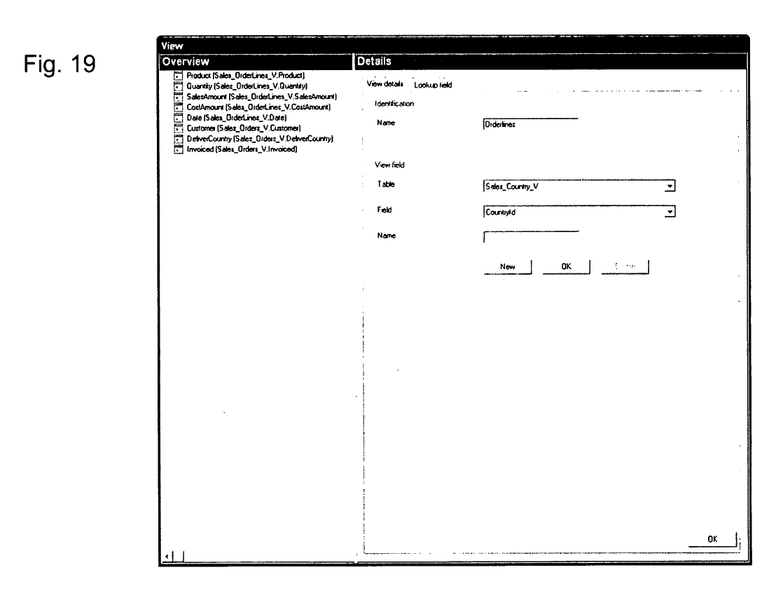

FIG. 19 illustrates a view used for generating a cube name “Sales”. The user is allowed to choose only among the valid tables corresponding to the original data selection in FIG. 15.

The view uses
“Sales_OrderLines_V.Product for “Product”;
“Sales_OrderLines_V.Quantity” for “Quantity”;
“Sales_OrderLines_V.SalesAmount” for “SalesAmount”;
“Sales_OrderLines_V.CostAmount” for “CostAmount”;
“Sales_OrderLines_V.Date” for “Date”;
“Sales_Order_V.Costumer” for “Customer”;
“Sales_Order_V.DeliverCountry” for “DeliverCountry”; and
“Sales_Order_V.Invoiced” for “Invoiced”.

The creation of this view is taken care of by an appropriately adapted execution stub added to the execution script. The execution stub will be based on the SQL statement CREATE VIEW. Since we have selected fields from different tables, they must be joined. We have declared that the key “OrderId” is common for the tables “Sales_Order_V” and “Sales_OrderLines_V” (see FIG. 9), and thus the view statement will contain an ON statement that selects for instance “Customer” from “Sales_Order_V” when “OrderId”—key for both tables—coincide.

The following execution stub creates the view:

```
CREATE VIEW dbo.view_Orderlines AS
SELECT TOP 100 PERCENT
      Sales_OrderLines_V.Product AS [Product],
      Sales_OrderLines_V.Quantity AS [Quantity],
      Sales_OrderLines_V.SalesAmount AS [SalesAmount],
      Sales_OrderLines_V.CostAmount AS [CostAmount],
      Sales_OrderLines_V.Date AS [Date],
      Sales_Orders_V.Customer AS [Customer],
      Sales_Orders_V.DeliverCountry AS [DeliverCountry],
      Sales_Orders_V.Invoiced AS [Invoiced]
FROM
      Sales_OrderLines_V
INNER JOIN
      Sales_Orders_V ON Sales_Orders_V.OrderId =
      Sales_OrderLines_V.OrderId
GO
```

At the end of this specification, in the section “COMPLETE STAGING SCRIPT”, we illustrate an execution script generated according to the method and adapted to carry out the actions described above. There are 9 tables in FIG. 9, and with table definitions, view definition and scrubbing we end up with more than 2000 code lines generated with very little input from the user, and because the execution stubs are predefined, the execution script will always be free of programming errors. 9 tables as in FIG. 9 is not necessarily a large project, and it is clear that the use of predefined query segments is highly efficient in forming both data warehouses comprising validated data and in the process that runs from extraction data from data sources to building OLAP cubes based on that data.

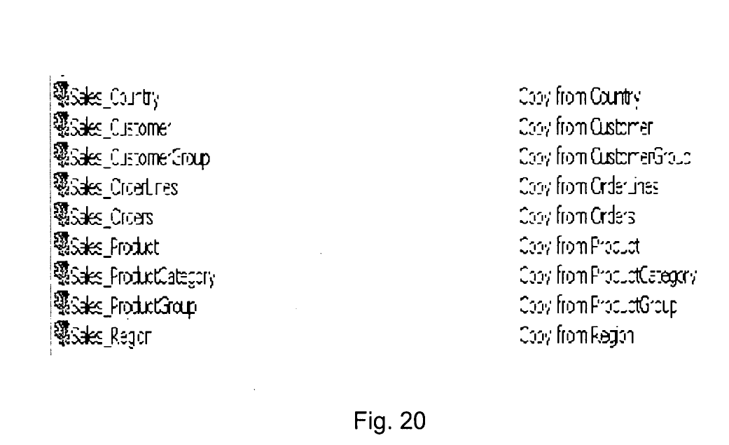

For completeness, FIG. 20 shows an overview of the DTS packages that copy the selected table tables from the data sources to the staging database.

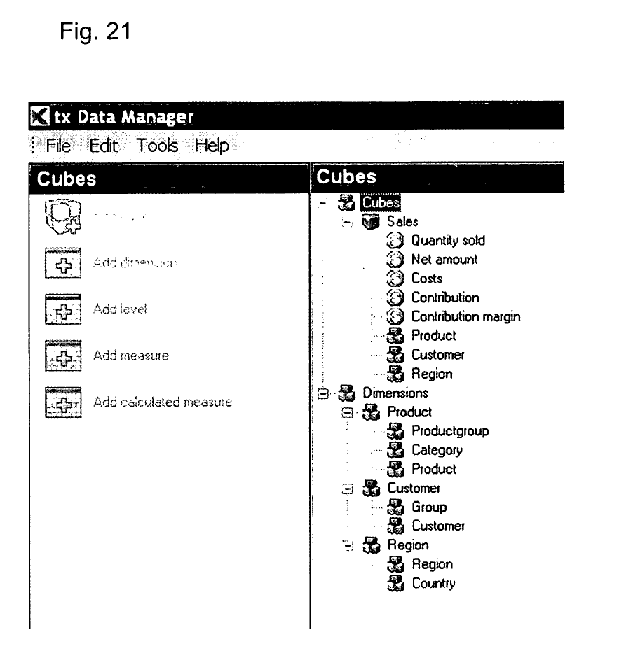

FIG. 21 illustrates a “Sales” cube having dimensions “Product”, “Customer”, and “Region”. The cube is based on the view in FIG. 19.

The dimension “Product” has levels “Productgroup”, “Category”, and “Product”. The dimension “Customer” has levels “Group” and “Customer”. The dimension “Region” has levels “Region” and “Country”. The cube is furthermore defined by measure “Quantity sold”, “Net amount”, “Costs”, “Contribution”, and “Contribution margin”. As FIG. 21 illustrates, all cubes, dimensions, levels and measures are defined via the interface without need for providing SQL code. As elsewhere in the method according to the first aspect, only information in the data selection is available for selection (see FIG. 15), removing the redundancy known from conventional approaches to building OLAP cubes, where the data warehousing and cube building are separated.

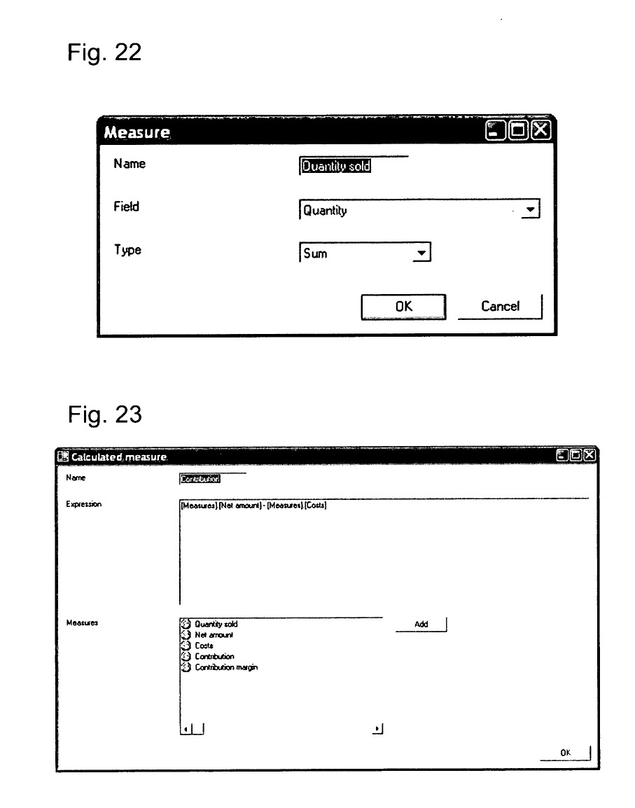

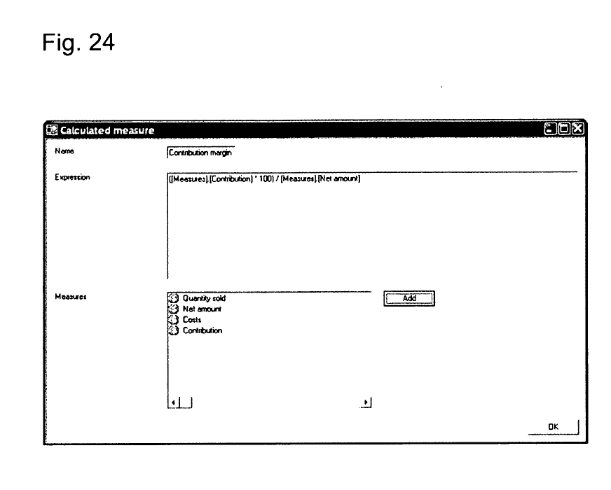

FIG. 22 illustrates the definition of a measure, in this case “Quantity sold”. The “Field” for this measure is “Quantity” from the fact table (FIG. 19). Furthermore, we have chosen aggregation type “Sum”. FIG. 23 illustrates a calculated measure, “Contribution”, based on a difference between the measures “Net amount” and “Costs”. FIG. 24 illustrates a calculated measure, “Contribution margin”, which is defined as the ratio between the measure “Contribution” from FIG. 23 and the measure “Net amount”.

When all the cube information has been provided, it is passed on to the API of a cube generation software application and the application has been executed, whereby the cube is generated.

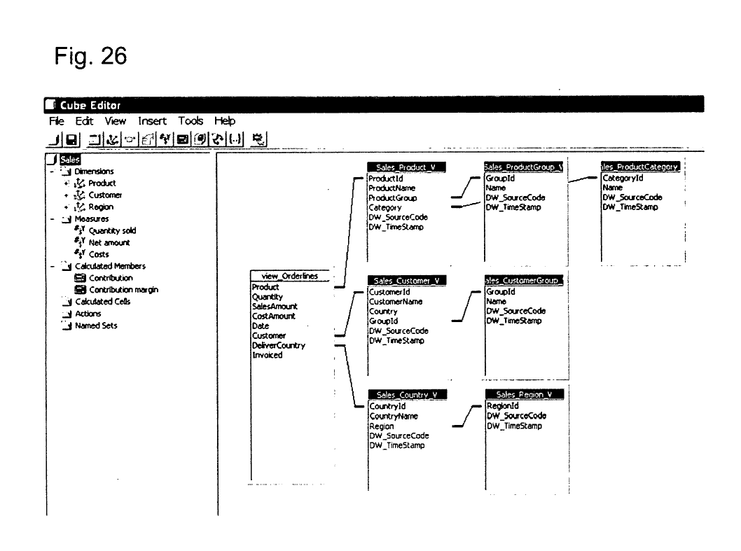

FIG. 26 illustrates what the final cube looks like when presented in an analysis tool such as Microsoft's Analysis Manager from Microsoft Analysis Service.

In some embodiments of the invention, a notification is presented when an error occurs during validation. In the present invention, we use error tables for storing row that do not comply with the validation rules. Below is a definition of the tables from FIG. 9. After the list of tables, we address how such a notification may appear.

TABLE “Orderlines”

| OrderId | LineNum | Product | Quantity | SalesAmount | CostAmount | Date |
|---|---|---|---|---|---|---|
| 1000 | 1 | 10 | 1 | 6784 | 9045,333 | 12-01-2006 |
| 1000 | 2 | 20 | 1 | 6179 | 8238,666 | 12-01-2006 |
| 1000 | 3 | 30 | 1 | 9846 | 13128 | 12-01-2006 |
| 1001 | 1 | 40 | 1 | 7975 | 10633,333 | 20-01-2006 |
| 1001 | 2 | 240 | 1 | 299 | 398,666 | 20-01-2006 |
| 1002 | 1 | 240 | 1 | 299 | 398,666 | 20-01-2006 |
| 1002 | 2 | 220 | 1 | 4599 | 6132 | 20-01-2006 |
| 1003 | 1 | 80 | 1 | 28950 | 38600 | 20-01-2006 |
| 1003 | 2 | 90 | 1 | 5275 | 7033,333 | 20-01-2006 |
| 1004 | 1 | 100 | 1 | 4275 | 5700 | 20-01-2006 |
| 1005 | 1 | 120 | 1 | 895,25 | 1193,666 | 01-02-2006 |
| 1005 | 2 | 200 | 1 | 5495 | 7326,666 | 01-02-2006 |
| 1005 | 3 | 210 | 1 | 1995 | 2660 | 01-02-2006 |
| 1006 | 1 | 220 | 3 | 11900 | 15866,666 | 01-02-2006 |
| 1006 | 2 | 230 | 2 | 9000 | 12000 | 01-02-2006 |
| 1007 | 1 | 240 | 20 | 50890 | 67853,333 | 02-02-2006 |
| 1008 | 1 | 250 | 1 | 35000 | 46666,666 | 02-02-2006 |
| 1008 | 2 | 10 | | 6784 | 9045,333 | 02-02-2006 |
| 1009 | 1 | 20 | 1 | 6179 | 8238,666 | 02-02-2006 |
| 1009 | 2 | 30 | 2 | 19692 | 26256 | 02-02-2006 |
| 1009 | 3 | 50 | 1 | 4623 | 6164 | 02-02-2006 |
| 1010 | 1 | 60 | 1 | 9865 | 13153,333 | 24-02-2006 |
| 1011 | 1 | 100 | 2 | 9000 | 12000 | 24-02-2006 |
| 1011 | 2 | 210 | 1 | 2995 | 3993,333 | 24-02-2006 |
| 1012 | 1 | 240 | 10 | 25445 | 33926,666 | 27-02-2006 |
| 1012 | 2 | 250 | 1 | 30000 | 40000 | 27-02-2006 |
| 1012 | 3 | 10 | 1 | 6784 | 9045,333 | 27-02-2006 |

TABLE “History_Orderlines”

| OrderId | LineNum | Product | Quantity | SalesAmount | CostAmount | Date |
|---|---|---|---|---|---|---|
| 0900 | 1 | 10 | 1 | 6784 | 9045,333 | 12-01-2005 |
| 0900 | 2 | 20 | 1 | 6179 | 8238,666 | 12-01-2005 |
| 0900 | 3 | 30 | 1 | 9846 | 13128 | 12-01-2005 |
| 0901 | 1 | 40 | 1 | 7975 | 10633,333 | 20-01-2005 |
| 0901 | 2 | 240 | 1 | 299 | 398,666 | 20-01-2005 |
| 0902 | 1 | 240 | 1 | 299 | 398,666 | 20-01-2005 |
| 0902 | 2 | 220 | 1 | 4599 | 6132 | 20-01-2005 |
| 0903 | 1 | 80 | 1 | 28950 | 38600 | 20-01-2005 |
| 0903 | 2 | 90 | 1 | 5275 | 7033,333 | 20-01-2005 |
| 0904 | 1 | 100 | 1 | 4275 | 5700 | 20-01-2005 |
| 0905 | 1 | 120 | 1 | 895,25 | 1193,666 | 01-02-2005 |
| 0905 | 2 | 200 | 1 | 5495 | 7326,666 | 01-02-2005 |
| 0905 | 3 | 210 | 1 | 1995 | 2660 | 01-02-2005 |
| 0906 | 1 | 220 | 3 | 11900 | 15866,666 | 01-02-2005 |
| 0906 | 2 | 230 | 2 | 9000 | 12000 | 01-02-2005 |
| 0907 | 1 | 240 | 20 | 50890 | 67853,333 | 02-02-2005 |
| 0908 | 1 | 250 | 1 | 35000 | 46666,666 | 02-02-2005 |
| 0908 | 2 | 10 | | 6784 | 9045,333 | 02-02-2005 |
| 0909 | 1 | 20 | 1 | 6179 | 8238,666 | 02-02-2005 |
| 0909 | 2 | 30 | 2 | 19692 | 26256 | 02-02-2005 |
| 0909 | 3 | 50 | 1 | 4623 | 6164 | 02-02-2005 |
| 0910 | 1 | 60 | 1 | 9865 | 13153,333 | 24-02-2005 |
| 0911 | 1 | 100 | 2 | 9000 | 12000 | 24-02-2005 |
| 0911 | 2 | 210 | 1 | 2995 | 3993,333 | 24-02-2005 |
| 0912 | 1 | 240 | 10 | 25445 | 33926,666 | 27-02-2005 |
| 0912 | 2 | 250 | 1 | 30000 | 40000 | 27-02-2005 |
| 0912 | 3 | 10 | 1 | 6784 | 9045,333 | 27-02-2005 |

TABLE “Orders”

| OrderId | Customer | Invoiced | DeliverCountry |
|---|---|---|---|
| 1000 | 1 | 1 | DK |
| 1001 | 1 | 1 | DK |
| 1002 | 2 | 1 | DE |
| 1003 | 2 | 1 | DE |
| 1004 | 3 | 1 | NZ |
| 1005 | 3 | 1 | NZ |
| 1006 | 4 | 1 | IT |
| 1007 | 4 | 1 | IT |
| 1008 | 5 | 1 | US |
| 1009 | 5 | 1 | US |
| 1010 | 6 | 0 | AU |
| 1011 | 6 | 0 | AU |
| 0900 | 1 | 1 | DK |
| 0901 | 1 | 1 | DK |
| 0902 | 2 | 1 | DE |
| 0903 | 2 | 1 | DE |
| 0904 | 3 | 1 | NZ |
| 0905 | 3 | 1 | NZ |
| 0906 | 4 | 1 | IT |
| 0907 | 4 | 1 | IT |
| 0908 | 5 | 1 | US |
| 0909 | 5 | 1 | US |
| 0910 | 6 | 0 | AU |
| 0911 | 6 | 0 | AU |

TABLE “Product”

| ProductId | ProductName | ProductGroup | Category |
|---|---|---|---|
| 10 | Lenovo Thinkpad R50e | 2 | 20 |
| 20 | Lenovo Thinkpad T43 | 2 | 20 |
| 30 | HP Business Notebook Nx6110 | 1 | 20 |
| 40 | HP Compaq Business Notebook | 1 | 20 |
| | Nx6125 | | |
| 50 | Thinkcentre A50 | 2 | 30 |
| 60 | Lenovo Thinkcentre S51 | 2 | 30 |
| 70 | HP Compaq Business Desktop | 1 | 30 |
| | Dc5100 | | |
| 80 | HP Workstation Xw8200 | 1 | 30 |
| 90 | Lenovo Thinkvision L151 | 2 | 10 |
| | (Business black) | | |
| 100 | Lenovo Thinkvision L151 | 2 | 10 |
| | (Silver) | | |
| 110 | Compaq TFT 5600 RKM | 1 | 10 |
| 120 | HP 90 (White) | 1 | 10 |
| 130 | IBM 670 watt | 2 | 40 |
| 140 | SDRAM PC133 1 × 256 | 2 | 40 |
| 150 | SDRAM PC133 1 × 512 | 2 | 40 |
| 200 | Microsoft Windows 2003 | 3 | 100 |
| 210 | Microsoft Windows XP Pro | 3 | 100 |
| 220 | Microsoft Office XP Pro | 3 | 200 |
| 230 | Microsoft Visio 2003 Pro | 3 | 200 |
| 240 | Trend Micro Officescan | 3 | 300 |
| 250 | Symantec Antivirus Enterprise | 3 | 300 |
| | Edition | | |

TABLE “ProductCategory”

| CategoryId | Name |
|---|---|
| 10 | Monitors |
| 20 | Laptops |
| 30 | Desktops |
| 40 | Parts |
| 100 | Operation Systems |
| 200 | Office applications |
| 300 | Antivirus |

TABLE “ProductGroup”

| GroupId | Name |
|---|---|
| 1 | Hewlett Packard |
| 2 | IBM |
| 3 | Software |

TABLE “Customer”

| CustomerId | CustomerName | Country | Group |
|---|---|---|---|
| 1 | John Doe | DK | 1 |
| 2 | Jane Doe | DE | 1 |
| 3 | Large Corp Inc | NZ | 2 |
| 4 | Small Corp Inc | IT | 2 |
| 5 | International Traders | US | 3 |
| 6 | First Class Imports | AU | 3 |

TABLE “CustomerGroup”

| GroupId | Name |
|---|---|
| 1 | Web |
| 2 | Retail |
| 3 | Distributers |

TABLE “Country”

| CountryId | CountryName | Region |
|---|---|---|
| AU | Australia | Pacific |
| BR | Brazil | Americas |
| CA | Canada | Americas |
| DE | Germany | EMEA |
| DK | Denmark | EMEA |
| HK | Hong Kong | EMEA |
| IT | Italy | EMEA |
| NZ | New Zealand | Pacific |
| US | United States of America | Americas |
| ZA | South Africa | EMEA |

TABLE “Region”
RegionId

Americas
EMEA
Pacific

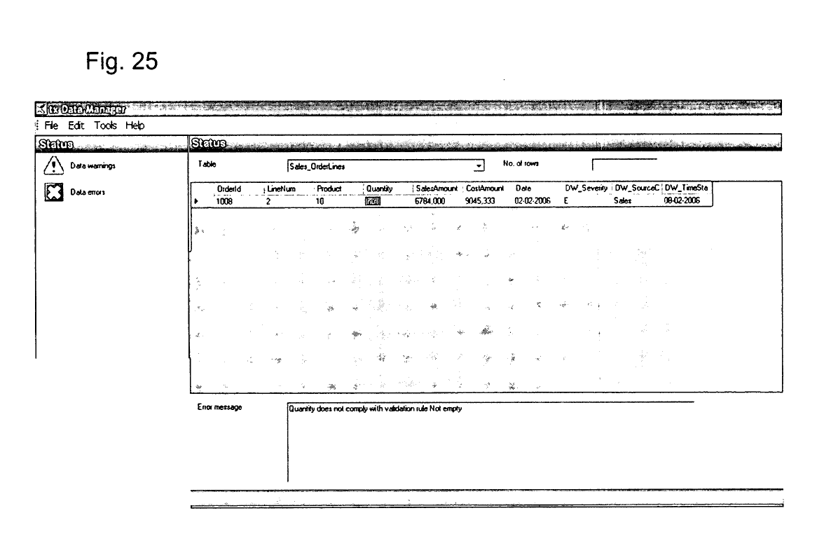

As mentioned in the beginning of the example in this section, we apply, for simplicity, the same validation rule for all fields in all tables, namely that they cannot be NULL or empty. The table “OrderLines” has an empty field, which violates the validation rule for that field in the “OrderLines” table. Hence, in accordance with methods of the invention, the row having the empty field is inserted into the error table. FIG. 25 illustrates an example of how such a notification may be presented to the user.

Along with the insertion of the row into the error table, another error indication may also be dispatched, for instance in the form of an email to relevant personnel. Preferably, the data warehousing is performed completely automatically once the execution script has been generated. Usually, the data warehousing takes place automatically, but in case a data source contains a field that violates the validation rules, this error must be communicated to the relevant personnel.

The examples provide illustrations of the principles behind the invention. The illustrations shall not be construed as limiting the scope defined by the claims.

1. A method allowing a user to generate an OLAP cube based on one or more data sources comprising a set of source tables having a set of source fields, the method comprising:
initializing an execution script configured to generate, when executed, a data warehouse configured to hold validated data based on said one or more data sources, the execution script also being configured to comprise execution stubs, execution stubs being predefined database query language segments comprising one or more database manipulation commands, wherein one or more of the database manipulation commands depends on parameters and selections provided with relation to said data sources;
performing a data selection comprising a set of tables and a set of fields selected from the source table and source fields;
performing each of the following for each table in said data selection:
adding to the execution script a table-specific execution stub representing a creation of a table-specific valid table, said valid table being a table adapted to hold validated rows, validated rows being rows that belong to said each table and comply with a table-specific set of validation rules provided for said each table, a validation rule being a field-specific condition that said specific field must fulfill; and
adding to the execution script a table-specific execution stub adapted to determine whether each row in said each table complies with the table-specific set of validation rules and if so, to insert said row into the table-specific valid table;
optionally creating a set of data warehouse views based on one or more of the valid tables that are to form part of said data warehouse, each data warehouse view is formed by carrying out each of the following:
selecting from the set of tables in the data selection a view-specific first view table to be used in said view;
selecting one or more fields from said view-specific first view table;
optionally:
selecting, from the set of tables in the data selection, a view-specific second view table to be used in said view;
selecting one or more fields from said view-specific second view table; and
providing a join criterion for joining said view-specific first and second view tables;
providing a name for said data warehouse view;
adding to the execution script a view execution stub representing a creation of said data warehouse view having said name and containing said selected fields from said view-specific first view table, said view execution stub further comprising, on the condition that said view-specific second view table has been selected, statements representing:
an inclusion of said selected fields from said view-specific second view table into said data warehouse view; and
the provided join criterion;
executing the execution script to form said data warehouse;
initializing a cube generation instruction set configured to generate said cube, the cube generation instruction set comprising a set of instructions, which when executed are configured to interact with an Application Programming Interface (API) of an OLAP cube generation software application and to cause said software application to generate an OLAP cube;
selecting a fact table for said cube, the fact table being either:
a table selected from the data warehouse; or
a view selected from the set data warehouse views, if created;
providing one or more cube dimensions that are to form part of said cube;
for each of said dimensions:
selecting a dimension-specific set of dimension tables on which said dimension shall be based, each dimension-specific table in said dimension-specific set of dimension tables forming a basis for one or more table-specific levels belonging to said dimension, the dimension-specific set of dimension tables being selected from one or both of:
the data warehouse; and
the set of data warehouse views, if created; and
for each dimension table in said dimension-specific set of dimension tables:
selecting, from said dimension table, a level-specific key field and a level-specific name field to form a level;
providing a set of measures configured to form part of said cube, each measure being provided with a measure-specific aggregation type, each measure being one of:
a standard measure based on a measure-specific field in the fact table;
a derived measure based on one or more fields in the fact table, said derived measure being calculated based on a measure-specific formula adapted to operate on said one or more fields, the derived measure being calculated before aggregation is performed on said measure in accordance with said measure-specific aggregation type;
a calculated measure based on at least one of:
one or more fields in the fact table;
another standard measure or measures from the set of measures; and
one or more other calculated measures from the set of measures;
wherein a calculation of a calculated measure is characterized by a multidimensional expression specific to said calculated measure;
adding to the cube generation instruction set a set of API instructions representing at least:
said provision of said dimensions;
said provision of said fact table;
said selection of said dimension-specific sets of dimension tables;
said selection of said level-specific key fields and name fields; and
said provision of said measures; and
providing said instruction set to said software application and executing said software application, thereby generating said cube.

2. The method according to claim 1, further comprising:
generating a staging database configured to hold staging data from said data sources, the staging data being data that correspond to said data selection;
performing the following for each specific table in the data selection:
adding to the execution script a table-specific execution stub representing a creation of a table-specific raw table in the staging database, said raw table being adapted to hold rows from said specific table;
copying, after executing the execution script, each table in the data selection from its data source to said table's corresponding raw table in the staging database; and
optionally applying a set of table-specific selection rules during said copying of said each table, the table-specific selection rules causing said copying to transfer only a part of said each table that complies with said table-specific set of selection rules, wherein said table-specific raw tables and valid tables are created in the staging database.

3. The method according to claim 1, further comprising:
performing the following for said each table:
adding to the execution script a table-specific execution stub representing a creation of a table-specific error table, said error table being adapted to hold erroneous rows, erroneous rows being rows that belong to said each table but do not comply with said table-specific set of validation rules; and
further adapting said table-specific execution stub so as to determine whether each row in said each table complies with the set of validation rules, and to insert said row into said table-specific error table if said row does not comply with said table-specific set of validation rules.

4. The method according to claim 1, wherein said table-specific execution stub is further adapted to apply to said each specific table one or both of: a table-specific set of transformation rules; and a table-specific set of default rules, wherein
a table-specific transformation rule comprises a field-specific operation configured to transform said specific field according to a field-specific scheme, said operation being configured to be applied only if a set of field-specific transformation conditions are fulfilled, and wherein
a table-specific default rule comprises a field-specific operation configured to set said specific field equal to a field-specific default value, said operation being configured to be applied only if a set of field-specific defaulting conditions are fulfilled.

5. The method according to claim 1, further comprising providing an error notification if, during said execution, it is determined by one of said table-specific execution stubs adapted to determine whether each row in said each table complies with said table-specific set of validation rules, that a row in said each table does not comply with said table-specific set of validation rules.

6. The method according to claim 5, wherein the error notification is configured to be provided to relevant personnel by way of at least one of: an email; a short text message; a fax; a page; and an entry in an operating system event log.

7. The method according to claim 1, wherein the execution stubs are based on the SQL query language.

8. The method according to claim 1, wherein said execution stubs are based on at least one of the following query languages: Business System 12; Tutorial D; TQL Proposal; Hibernate Query Language (HQL); Object-oriented SQL (OSQL); Quel, C#; VB.NET; Multidimensional Expression Language (MDX); and Procedural Language extensions to SQL (PL/SQL).

9. The method according to claim 1, further comprising saving information pertaining to said OLAP cube generation in a project file on a storage medium.

10. The method according to claim 9, wherein the project file is human-readable.

11. The method according to claim 1, wherein the instruction set is based on one of: Analysis Management Objects (AMO); Decision Support Objects (DSO); Oracle OLAP API.

12. The method according to claim 1, further comprising using a graphical user interface (GUI).

13. A method of allowing a user to generate a data warehouse holding validated information based on one or more data sources comprising a set of source tables having a set of source fields, the method comprising:
initializing an execution script configured to generate, when executed, said data warehouse configured to hold validated data based on said one or more data sources, the execution script also being adapted to comprise execution stubs, execution stubs being predefined database query language segments comprising one or more database manipulation commands, wherein one or more of the database manipulation commands depend on parameters and selections provided with relation to said data sources;
performing a data selection comprising a set of tables and a set of fields selected from the source table and source fields;
performing each of the following for each table in said data selection:
adding to the execution script a table-specific execution stub representing a creation of a table-specific valid table, said valid table being a table adapted to hold validated rows, validated rows being rows that belong to said each table and comply with a table-specific set of validation rules provided for said each table, a validation rule being a field-specific condition that said specific field must fulfill; and
adding to the execution script a table-specific execution stub adapted to determine whether each row in said each table complies with the table-specific set of validation rules and if so, to insert said row into the table-specific valid table;
optionally creating a set of data warehouse views based on one or more of the valid tables that are to form part of said data warehouse, each data warehouse view is formed by carrying out each of the following:
selecting from the set of tables in the data selection a view-specific first view table to be used in said view;
selecting one or more fields from said view-specific first view table;
optionally:
selecting, from the set of tables in the data selection, a view-specific second view table to be used in said view;
selecting one or more fields from said view-specific second view table; and
providing a join criterion for joining said view-specific first and second view tables;
providing a name for said data warehouse view;
adding to the execution script a view execution stub representing a creation of said data warehouse view having said name and containing said selected fields from said view-specific first view table, said view execution stub further comprising, on the condition that said view-specific second view table has been selected, statements representing:
an inclusion of said selected fields from said view-specific second view table into said data warehouse view; and
the provided join criterion; and
executing the execution script to form said data warehouse.

14. The method according to claim 13, further comprising:
generating a staging database configured to hold staging data from said data sources, the staging data being data that correspond to said data selection;
performing the following for each specific table in the data selection:
adding to the execution script a table-specific execution stub representing a creation of a table-specific raw table in the staging database, said raw table being adapted to hold rows from said specific table;
copying, after executing the execution script, each table in the data selection from its data source to said table's corresponding raw table in the staging database; and
optionally applying a set of table-specific selection rules during said copying of said each table, the table-specific selection rules causing said copying to transfer only a part of said each table that complies with said table-specific set of selection rules, wherein
said table-specific raw tables and valid tables are created in the staging database.

15. The method according to claim 13, further comprising:
performing the following for said each table:
adding to the execution script a table-specific execution stub representing a creation of a table-specific error table, said error table being a table adapted to hold erroneous rows, erroneous rows being rows that belong to said each table but do not comply with said table-specific set of validation rules; and
further adapting said table-specific execution stub so as to determine whether each row in said each table complies with the set of validation rules, and to insert said row into said table-specific error table if said row does not comply with said table-specific set of validation rules.

16. The method according to claim 13, wherein said table-specific execution stub is further adapted to apply to said each specific table one or both of: a table-specific set of transformation rules; and a table-specific set of default rules, wherein
a table-specific transformation rule comprises a field-specific operation configured to transform said specific field according to a field-specific scheme, said operation being configured to be applied only if a set of field-specific transformation conditions are fulfilled, and wherein
a table-specific default rule comprises a field-specific operation configured to set said specific field equal to a predefined field-specific default value, said operation being configured to be applied only if a set of field-specific defaulting conditions are fulfilled.

17. The method according to claim 13, further comprising providing an error notification if, during said execution, it is determined by one of said table-specific execution stubs adapted to determine whether each row in said each table complies with said table-specific set of validation rules, that a row in said each table does not comply with said table-specific set of validation rules.

18. The method according to claim 17, wherein the error notification is configured to be provided to relevant personnel by way of at least one of: an email; a short text message; a fax; a page; and an entry in an operating system event log.

19. The method according to claim 13, wherein the execution stubs are based on the SQL query language.

20. The method according to claim 13, wherein said execution stubs are based on at least one of the following query languages: Business System 12; Tutorial D; TQL Proposal; Hibernate Query Language (HQL); Object-oriented SQL (OSQL); Quel, C#; VB.NET; Multidimensional Expression Language (MDX); and Procedural Language extensions to SQL (PL/SQL).

21. The method according to claim 13, further comprising saving information pertaining to said data warehouse in a project file on a storage medium.

22. The method according to claim 21, wherein the project file is human-readable.

23. The method according to claim 13, further comprising using a graphical user interface (GUI).

24. A computer readable medium comprising software, which, when executed performs the method of claim 1.

25. Hardware adapted to perform the method of claim 1.

26. A computer readable medium comprising software, which, when executed performs the method of claim 13.

27. Hardware adapted to perform the method of claim 13.
